(19) United States
(12) Patent Application Publication
(10) Pub. No.: US 2008/0177447 A1
(43) Pub. Date: Jul. 24, 2008

(54) Automobile protection system with road information indication

(76) Inventor: Ming-Hui Hsiang, Jiali Township (TW)

Correspondence Address: Ming-Hui Hsiang, 235 Chung - Ho Box 8-24, Taipei, omitted

(21) Appl. No.: 11/656,032

(22) Filed: Jan. 22, 2007

(51) Int. Cl. B60R 25/00; G08G 1/01

(52) U.S. Cl. 701/45; 701/117

(57) ABSTRACT

An automobile protection system with road information indication mainly comprises a road information indicator installed in a car and a road information integration system linked to the road information indicator by a wireless communication means. The road information integration system is managed by a system manager, whereby the car driver can acquire road and car information at once. At the same time, the driver can pass the road information to other drivers. Thereby, the car driver and others can dodge traffic jams and reach a destination quickly, saving time and fuel. Further, an anti-theft interface of the road information indicator can detect the car conditions and report to the car owner's controller via the road information integration system.

### FIELD OF THE INVENTION

The present invention relates to automobile protection systems, more particularly to an automobile protection system with road information indication mainly comprising a road information indicator installed in a car and a road information integration system linked to the road information indicator by a wireless communication means. The road information integration system is managed by a system manager, whereby the car driver can acquire road and car information at once. At the same time, the driver can pass the road information to other drivers. Thereby, the car driver and others can dodge traffic jams and reach a destination quickly, saving time and fuel. Further, an anti-theft interface of the road information indicator can detect the car conditions and report to the car owner's controller via the road information integration system.

### BACKGROUND OF THE INVENTION

The road information for a car driver to understand the traffic conditions he or she is heading to is conventionally acquired by AM/FM radio broadcast, which is easy to be blocked by nearby mountains. Nowadays, even some of automobiles have TV and Internet communication, the vulnerability to terrains is the same.

On the other hand, many important road sections have been equipped with on-site display for providing instant road information and other related data (e.g. speed). However, a car driver cannot see the data in advance, and the data needed to be filtered by the driver for getting the information he or she needs. At the same time, a driver can transmit the road situation he or she had seen to radio stations through cell phones for sharing with other car drivers. But making calls by a driver inside a traveling car is forbidden now.

Further, the anti-theft devices of the prior art are mainly locks and alarms. The former device cannot resist car theft skilful at unlocking car locks. The latter needs that the car owner to keep within a range so that he or she can hear the alarm or that another person walking by and report to the police in time, which is therefore not practical. Some of the alarms have the function of wireless communication by which the owner can be notified of the situation from a receiver he or she is carrying. However, the owner has to carry the receiver always and there is no obstacle between the car and the receiver for assuring the communication, which is also not practical.

### SUMMARY OF THE INVENTION

Accordingly, the primary objective of the present invention is to provide an automobile protection system with road information indication by which the car driver can acquire road and car information timely. Further, the driver can pass the road information to other drivers. Thereby, the car driver and others can dodge traffic jams and reach a destination quickly, saving time and fuel. Further, an anti-theft interface of the road information indicator can detect the car conditions and report to the car owner's controller via the road information integration system.

To achieve above object, the present invention provides an automobile protection system with road information indication, which integrates a road information indicator and a road information integration system, wherein said road information indicator which comprises a shell having a receptacle, a plurality of ventilation holes and a plurality of screw holes and slots in said receptacle; a circuit unit housed within said receptacle of said shell and further comprising a plurality of circuit boards, a display, a matrix of buttons and a battery set, said circuit boards being respectively connected to a GSM communication device for the insertion of an SIM card, an MCU microprocessor connected to said GSM communication device, a GPS receiver connected to said MCU microprocessor for receiving satellite positioning signals in the air and computing location, a GPRS communication module connected to said MCU microprocessor for transmitting road information to said road information integration system, a CIS communication module connected to said MCU microprocessor for transmitting automobile location to said road information integration system, a GSM communication module connected between said MCU microprocessor and said GSM communication device for cell phone communications, a telephone interface connected to said GSM communication device for remote monitoring, a controller-signal receiving interface connected to said MCU microprocessor for receiving signals from a controller, an anti-theft interface connected to said MCU microprocessor for sensing current automobile conditions, and an RF receiver connected to said anti-theft interface for receiving RF radio signals; and a cover connected to said shell and having a window for a display of said circuit unit and a button board corresponding to a matrix of buttons on said circuit unit.

Moreover the present invention provides an automobile protection system with road information indication, which integrates a road information indicator and a road information integration system, wherein said road information integration system which comprises a GPRS server linked to the Internet for transmitting data to and receiving data from said road information indicator; a car information processing server linked to the Internet for saving road information from said road information indicator; a hub connected to said GPRS server and said car information processing server for centralized management by a system manager; an SQL server connected to said hub for storing inquiry phrases; a fleet server connected to said hub for storing road information for managing client car fleet; a road information broadcasting unit linked to the Internet for said system manager to announce road information; and a car location monitoring unit linked to the Internet for said system manager to monitor car locations.

### BRIEF DESCRIPTION OF THE DRAWINGS

FIG. 1 is an exploded perspective view of the present invention.

FIG. 2 is a system diagram of the circuit board of the present invention.

FIG. 3 is a perspective view of the present invention.

FIG. 4 is a first system block diagram of the present invention.

FIG. 5 is a second system block diagram of the present invention.

### DETAILED DESCRIPTION OF THE PREFERRED EMBODIMENTS

The various objects and advantages of the present invention will be more readily understood from the following detailed description when read in conjunction with the appended drawings.

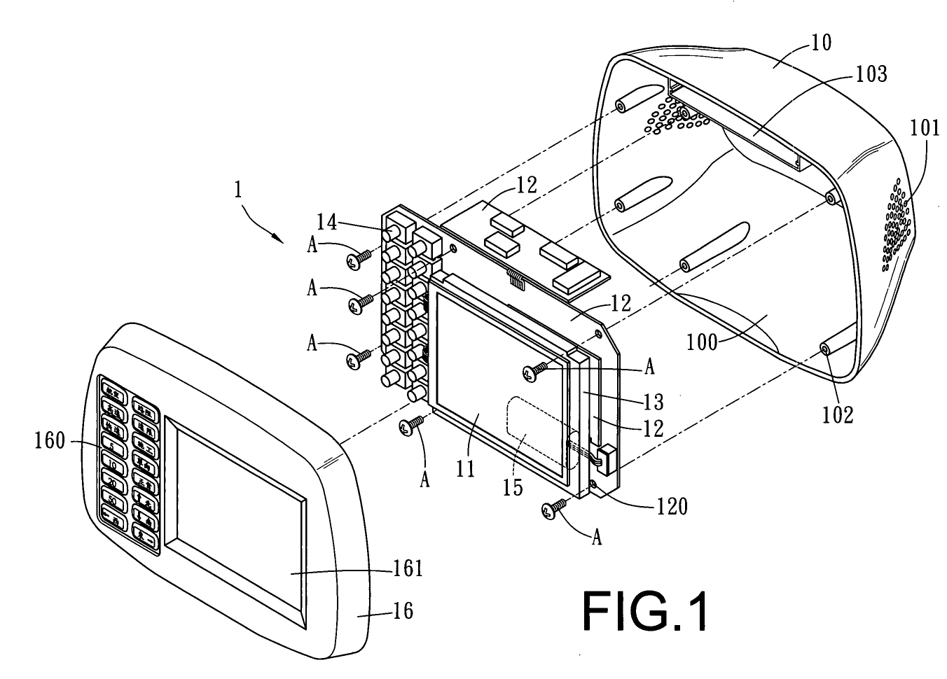

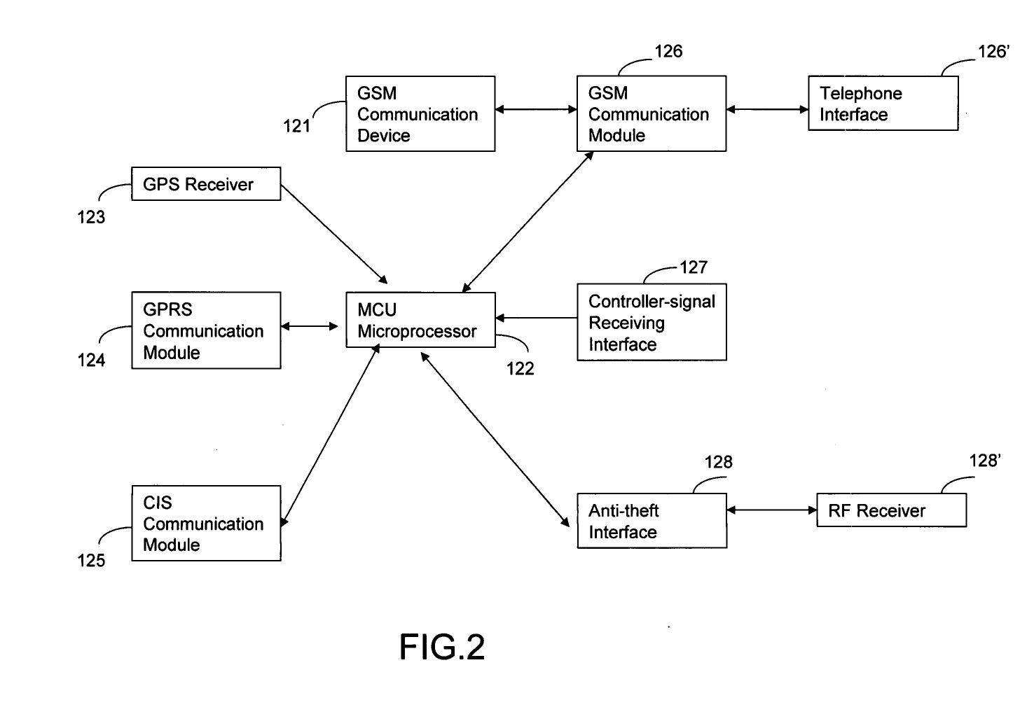

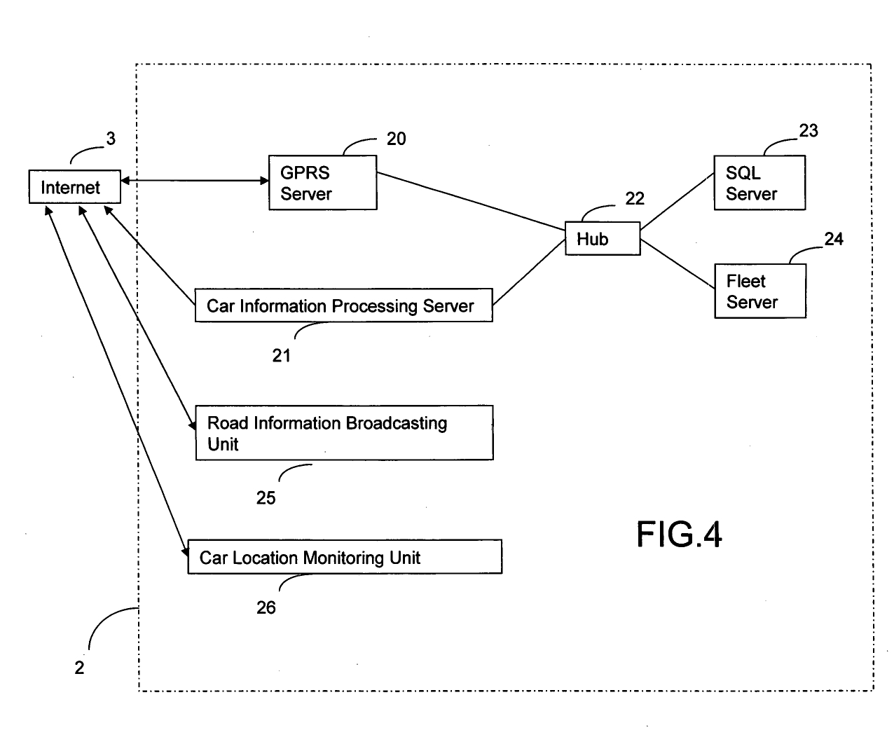

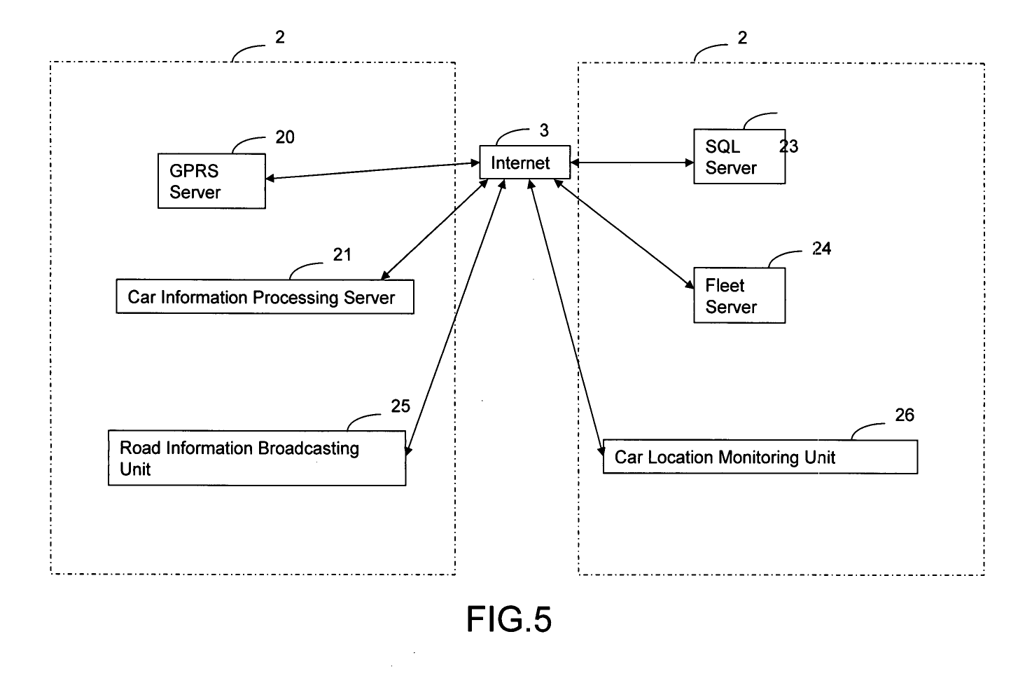

Referring to FIGS. 1 to 3, an automobile protection system with road information indication of the present invention mainly comprises a road information indicator 1 and a road information integration system 2, which are wireless connected to each other by communications, as shown in FIGS. 4 and 5. The road information indicator 1 further comprises a shell 10, a circuit unit 11 and a cover 16. The shell 10 has a receptacle 100, a plurality of ventilation holes 101 and a plurality of screw holes 102 and slots in said receptacle 103. The a circuit unit 11 is housed within the receptacle 100 of the shell 10 and further comprises a plurality of circuit boards 12, a display 13, a matrix of buttons 14 and a battery set 15. The circuit boards 12 are respectively connected to a GSM communication device 121 for the insertion of an SIM card, an MCU microprocessor 122 connected to the GSM communication device 121, a GPS receiver 123 connected to the MCU microprocessor 122 for receiving satellite positioning signals in the air and computing location, a GPRS communication module 124 connected to the MCU microprocessor 122 for transmitting road information to the road information integration system 2, a CIS communication module 125 connected to the MCU microprocessor 122 for transmitting automobile location to the road information integration system 2, a GSM communication module 126 connected between the MCU microprocessor 122 and the GSM communication device 121 for cell phone communications, a telephone interface 126′ connected to the GSM communication device 126 for remote monitoring, a controller-signal receiving interface 127 connected to the MCU microprocessor 122 for receiving signals from a controller, an anti-theft interface 128 connected to the MCU microprocessor 122 for sensing current automobile conditions, and an RF receiver 128′ connected to the anti-theft interface 128 for receiving RF radio signals. The cover 16 is connected to the shell 10 and has a window for a display of the circuit unit 11 and a button board 160 corresponding to a matrix of buttons 14 on the circuit unit 11.

The automobile protection system with road information indication can be installed with a SIM card containing all control parameters. Therefore, when the GSM communication device 121 is out of order, the SIM card can be reinserted into a new GSM communication device, restoring all control settings at once.

The MCU processor 122 of the automobile protection system with road information indication further comprises a computing unit, a memory module, a serial bus, an input interface, an output interface, a programmable logic gate and four universal asynchrony receiver/transmitter (UART) respectively for connecting the GPS receiver 123, the GPRS communication module 124, the controller and an optional customized expansion point. The MCU processor 122 further comprises an analog to digital signal converter powered by an external power supply, an internal backup detecting unit, two time-pulse oscillators respectively for normal usage and energy-saving-mode usage. The MCU processor 122 further comprises 64K bytes of Flash EPROM and 4 bytes of SRAM, expandable up to 2 M bytes of Flash EPROM, for storing road information. The MCU processor 122 further comprises a temperature controller that will shut off the display 13 when operating temperature exceeds 50° C. for protection.

The controller of the automobile protection system with road information indication encodes data into high frequency signals for transmission. The controller-signal receiving interface 127 then deciphers received signal. The controller has 14 buttons that are respectively an SOS help button, an anti-theft setting button, an anti-theft relief button, a testing function button, a talk button, a air-pressure initiating alarm setting button, a vibration initiating alarm setting button, a door-open initiating alarm setting button, an optional initiating alarm setting button and an audio monitoring button.

The anti-theft interface 128 includes functions of engine-start detection, car-door detection, vibration sensing, micro-vibration sensing, tow sensing, ultra-sonic sensing, radio emission sensing and rolling-ball vibration sensing. The anti-theft interface 128 automatically enters a state selected from an energy-saving mode and a preset mode, when the car driver leaves the automobile.

The RF receiver 128′ can be used with a personal help button and a radio-controlled air-pumped transmission lock, thereby being capable of receiving signals from the personal help button and the radio-controlled air-pumped transmission lock and then calling the road information integration system 2.

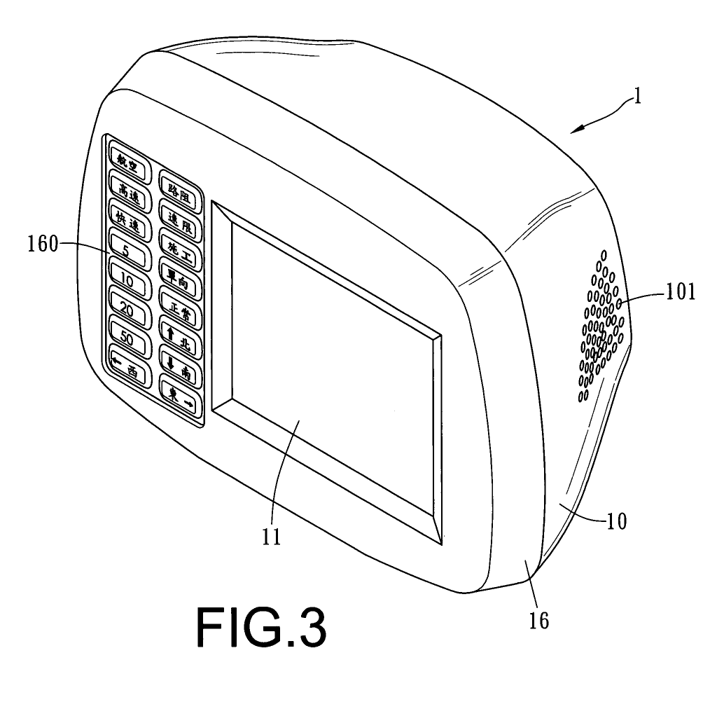

As shown in FIGS. 1 and 3, to assemble the automobile protection system with road information indication of the present invention, the circuit unit 11 is placed in the receptacle 100 of the shell 10, and then a plurality of screws A are inserted through the through holes 120 on the circuit boards 12 into the screw holes 102. The cover 16 is then integrated with the shell 10, whereby the button board 160 on the cover 16 is aligned with the button matrix 14 on the circuit unit 11. Further, the window 161 will be aligned with the display 13 on the circuit unit 11.

The road information indicator 1 of the of the present invention includes 16 hot keys respectively for airport, highway, expressway, 5 KM, 10 KM, 20 KM, 50 KM, west, road block, speed limit, construction, one way, normal, north, south and east, in which the keys indicated by 5 KM, 10 KM, 20 KM and 50 KM are for providing road information of corresponding distances. The keys indicated by east, south, west and north are for providing related road information in respectively directions. The “airport” key is for providing the car driver with nearby road and location information of airports. The “highway” key is for providing the car driver with nearby information of highways. The “expressway” is for providing the car driver with nearby information of expressways. For example, when the car driver pushes the “expressway” key, he or she can get road information of nearby expressways. When the car driver pushes the “5 KM” key and the “north” key at the same time, he or she can get the road information in the north direction 5 KM away. When the driver pushes the “road block”, “construction” or “one way”, the coordinates, direction, speed and road information will be transmitted back to the road information integration system 2 for organization. The reported road situation by the driver will be re-distributed to other drivers for precaution. Therefore, when the driver pushes the “speed limit” key, he or she can get the information of car moving speed limits. When the driver pushes the “normal” key, he or she can get the road information around the car location.

The display 13 of the circuit unit 11 of the road information indicator 1 of the present invention is controlled by the car driver via the button board 160. When the driver pushes the button “Normal”, the following picture is displayed.

| | | |
|---|---|---|
| 12:08:30 | GPRS | GPS |
| 12:08:30 | GPRS | GPS |
| You are currently at Yingge, Taipei County | | |
| 45 KM, National Highway No.3 | | |

| | |
|---|---|
| Sindian Interchange | slow |
| Jhonghe Interchange | jammed |
| Hsuehshan Tunnel | 50 KM/h |

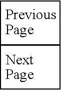

The above example displayed in the display 13 shows GPS time on the upper left and GPRS on the upper right. The GPRS displayed in capital letters indicates normal and in lowercase letters indicates abnormal. By the same token, the GPR displayed in capital letters indicates normal and in lowercase letters indicates abnormal. The central portion of the display 13 shows the road information, and the option of Previous Page/Next Page is indicated on the lower right.

When an automobile protection system with road information indication of the present invention is in use, the car driver can acquire road and car information at once, because of the communication between the road information indicator 1 and the road information integration system 2. At the same time, the driver can pass the road information to other drivers. Thereby, the car driver and others can dodge traffic jams and reach a destination quickly, saving time and fuel. Further, the anti-theft interface 128 of the road information indicator 1 can effectively detect the car conditions and report to the car owner's controller via the road information integration system 2.

Referring to FIGS. 1 and 4, the second preferred embodiment of the present invention has a road information integration system 2 comprising a GPRS server 20, a car information processing server 21, a hub 22, an SQL server 23, a fleet server 24, a road information broadcasting unit 25 and a car location monitoring unit 26. The GPRS server 20 is linked to the Internet for transmitting data to and receiving data from the road information indicator 1. The car information processing server 21 is linked to the Internet for saving road information from the road information indicator 1. The hub 22 is connected to the GPRS server 20 and the car information processing server 21 for centralized management by a system manager. The SQL server 23 is connected to the hub 22 for storing inquiry phrases. The fleet server 24 is connected to the hub 22 for storing road information for managing client car fleet. The road information broadcasting unit 25 is linked to the Internet for the system manager to announce road information. The car location monitoring unit 26 is linked to the Internet for the system manager to monitor car locations.

This preferred embodiment connects, achieving a management system comprising the steps of:
1. information organization by which the system manager classifies the road information from either Internet providers or car drivers and does necessary statistical and time analysis for preventing error messages;
2. information integration by which the road information is attached with coordinates and speed for transmitting back to the road information indicator 1; and
3. information display and indication by which the information sent back to the road information indicator 1 from the road information integration system 2 and then displays on the display 13, simultaneously with a beep; wherein the stored message can attain 100 messages, over which the initial messages can be automatically deleted or marked for protection.

The automobile protection system with road information indication of the present invention has an independent fleet server 24 for storing road information associated with the car fleet it manages, whereby the system manager can monitor the history of any of the car fleet. Therefore, there are a GPRS server 20, a car information processing server 21, an SQL server 23, said fleet server 24, which respectively have self-detecting mechanisms for notifying said system manager machine anomaly by sending out SMS messages to said system manager. Further, all servers and the road information broadcasting unit 25 and the car location monitoring unit 16 can be distributed in different places and connected by the Internet.

The number of monitors for the system manager supervising the automobile protection system with road information indication of the present invention can be increased by a device that converts USB signals into VGA signals, whereby a plurality of monitoring screens will be displayed on a single webpage. The system manager inputs road information through marking on an electronic map, drawing a region whose shape selected from a rectangle, a line and a polygon.

When an automobile protection system with road information indication of the present invention is in use, the car driver can acquire road and car information at once, because of mutual communication between the road information indicator 1 and the road information integration system 2. At the same time, the driver can pass the road information to other drivers. Thereby, the car driver and others can dodge traffic jams and reach a destination quickly, saving time and fuel. Further, the anti-theft interface 128 of the road information indicator 1 can effectively detect the car conditions and report to the car owner's controller via the road information integration system 2.

The present invention has the advantages as follows.

1. The present invention can effectively y help a car driver to pass by traffic jams and to reach a destination quickly, therefore saving time and fuel. It is a tool of energy conservation upon the incoming age of high fuel price.

2. The present invention is easy to control by the car driver, whereby the driver will acquire desired road information timely. At the same time, the driver can pass the road information to other drivers.

3. The present invention has the flexibility of adding optional devices such as personal emergency call button and wireless gas-pumped transmission lock, whereby any message relating to car theft will be transmitted to the road information integrating system and the car owner.

4. The present invention is equipped with an SIM card containing all control parameters, and therefore, when a GSM communication device is out of order, the SIM card can be reinserted into a new GSM communication device, restoring all control settings at once.

5. The servers associated with the present invention can be stored at a site and connected by a HUB. They can also be located at different sited, by connected the Internet.

6. The servers associated with the present invention have a function of self detection, whereby when a server fails to send normal signals in a preset time period, the system manager will be notified remotely by a radio message, so that he or she can come back to fix the server in time.

The present invention is thus described, and it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. An automobile protection system with road information indication, which integrates a road information indicator and a road information integration system, wherein said road information indicator comprising:
a shell having a receptacle, a plurality of ventilation holes and a plurality of screw holes and slots in said receptacle;
a circuit unit housed within said receptacle of said shell and further comprising a plurality of circuit boards, a display, a matrix of buttons and a battery set, said circuit boards being respectively connected to a GSM communication device for the insertion of an SIM card, an MCU microprocessor connected to said GSM communication device, a GPS receiver connected to said MCU microprocessor for receiving satellite positioning signals in the air and computing location, a GPRS communication module connected to said MCU microprocessor for transmitting road information to said road information integration system, a CIS communication module connected to said MCU microprocessor for transmitting automobile location to said road information integration system, a GSM communication module connected between said MCU microprocessor and said GSM communication device for cell phone communications, a telephone interface connected to said GSM communication device for remote monitoring, a controller-signal receiving interface connected to said MCU microprocessor for receiving signals from a controller, an anti-theft interface connected to said MCU microprocessor for sensing current automobile conditions, and an RF receiver connected to said anti-theft interface for receiving RF radio signals; and
a cover connected to said shell and having a window for a display of said circuit unit and a button board corresponding to a matrix of buttons on said circuit unit.

2. The automobile protection system with road information indication of claim 1 wherein said SIM card contains all control parameters; therefore, when a GSM communication device is out of order, said SIM card can be reinserted into a new GSM communication device, restoring all control settings at once.

3. The automobile protection system with road information indication of claim 1 wherein said MCU processor further comprises a computing unit, a memory module, a serial bus, an input interface, an output interface, a programmable logic gate and four universal asynchrony receiver/transmitter (UART) respectively for connecting said GPS receiver, said GPRS communication module, said controller and an optional customized expansion, and wherein said MCU processor further comprises an analog to digital signal converter powered by an external power supply, an internal backup detecting unit, two time-pulse oscillators respectively for normal usage and energy-saving-mode usage, and wherein said MCU processor further comprises 64K bytes of Flash EPROM and 4 bytes of SRAM, expandable up to 2 M bytes of Flash EPROM, for storing road information, and wherein said MCU processor further comprises a temperature controller that will shut off said display when operating temperature exceeds 50° C. for protecting said display.

4. The automobile protection system with road information indication of claim 1 wherein said controller encoding data into high frequency signals for transmission, and wherein said controller-signal receiving interface deciphers received signals; said controller having 14 buttons that are an SOS help button, an anti-theft setting button, an anti-theft relief button, a testing function button, a talk button, a air-pressure initiating alarm setting button, a vibration initiating alarm setting button, a door-open initiating alarm setting button, an optional initiating alarm setting button and an audio monitoring button.

5. The automobile protection system with road information indication of claim 1 wherein said anti-theft interface includes functions of engine-start detection, car-door detection, vibration sensing, micro-vibration sensing, tow sensing, ultra-sonic sensing, radio emission sensing and rolling-ball vibration sensing; said anti-theft interface automatically entering a state selected from an energy-saving mode and a preset mode when a car driver leaves said automobile.

6. The automobile protection system with road information indication of claim 1 wherein said RF receiver can be used with a personal help button and a radio-controlled air-pumped transmission lock, thereby being capable of receiving signals from said personal help button and said radio-controlled air-pumped transmission lock and then calling said road information integration system.

7. The automobile protection system with road information indication of claim 1 wherein said button board includes classified functions of airport, highway, expressway, 5 KM, 10 KM, 20 KM, 50 KM, west, road block, speed limit, construction, one way, normal, north, south and east.

8. An automobile protection system with road information indication, which integrates a road information indicator and a road information integration system, wherein said road information integration system comprising:
a GPRS server linked to the Internet for transmitting data to and receiving data from said road information indicator;
a car information processing server linked to the Internet for saving road information from said road information indicator;
a hub connected to said GPRS server and said car information processing server for centralized management by a system manager;
an SQL server connected to said hub for storing inquiry phrases;
a fleet server connected to said hub for storing road information for managing client car fleet;
a road information broadcasting unit linked to the Internet for said system manager to announce road information; and
a car location monitoring unit linked to the Internet for said system manager to monitor car locations.

9. The automobile protection system with road information indication of claim 8 wherein said GPRS server, said car information processing server, said SQL server, said fleet server, said road information broadcasting unit and said car location monitoring unit are distributed in different places and connected by the Internet.

10. The automobile protection system with road information indication of claim 8 wherein said GPRS server, said car information processing server, said SQL server, said fleet server, said road information broadcasting unit and said car location monitoring unit respectively have self-detecting mechanisms for notifying said system manager machine anomaly by sending out SMS messages to said system manager.

11. The automobile protection system with road information indication of claim 8 wherein monitors for said system manager are increased by a device that converts USB signals into VGA signals, thereby a plurality of monitoring screens being displayed on a single webpage.

12. The automobile protection system with road information indication of claim 8 wherein said system manager inputs road information through marking on an electronic map, drawing a region whose shape selected from a rectangle, a line and a polygon.
